(19) United States
(12) Patent Application Publication
(10) Pub. No.: US 2017/0370079 A1
(43) Pub. Date: Dec. 28, 2017

(54) Safety Clean-out Cap

(71) Applicant: Otilia Sfredel, Chicago, IL (US)

(72) Inventors: Costel Sfredel, Chicago, IL (US); Otilia Sfredel, Chicago, IL (US)

(21) Appl. No.: 15/194,907

(22) Filed: Jun. 28, 2016

(51) Int. Cl. E03C 1/30; F16L 55/115

(52) U.S. Cl. CPC E03C 1/30; F16L 55/1152

(57) ABSTRACT

This safety clean-out cap system provides for the removal of water and debris from drains. It consists of a flow channel that is mounted within the opening of a clean-out cap. The flow channel is diametrically opposed to the top surface of the clean-out cap and bends at a 90-degree angle just below a rectangular recess. The rectangular recess has a grab portion that cooperatively receives a tool. Additional embodiments of the safety clean-out cap system include clean-out caps having channel extensions and a square-shaped channel. The channel extensions extend at a 180-degree angle from the clean-out cap and have a plurality of longitudinal rails and longitudinal plates that further facilitate the removal of the clean-out cap from drainpipes. The clean-out cap and the additional embodiments are attached to fittings, pipe sections and hose sections in order to regulate the flow of water and debris from a drain.

### BACKGROUND OF THE INVENTION

The present invention relates to the field of plumbing and drain clean-out devices. More particularly, the present invention pertains to embodiments of a safety clean-out cap (hereinafter clean-out cap) with compression surface areas to grip the clean-out cap before removal from a drainage system. The clean-out cap is adapted to connect to plumbing extensions for flushing water and debris from a drain in narrow, tight or constricted conditions by means of flow channel systems.

Clean-outs are access points or fittings for drain openings. These are specialized devices that maintain the integrity of a plumbing system over extended periods of time. Plumbing codes have requirements for the size, location, installation and maintenance of drainage pipe clean-outs. This is mainly dictated by the necessity to allow drain cleaning devices to have access to drainage pipes.

Most plumbing systems are designed by professionals who make clean-outs accessible by placing them at convenient intervals and with minimal disruptions to a building. For example, interior building drains can be routed in a manner that would not permit clean-outs to be located above or near high traffic areas, electrical boxes, large mechanical units or equipment that would require removal before accessing the drainage system.

The release of sewer into a home or public building can pose serious health risks. The sewer can vary from clean water to raw sewage that contains fecal matter, bacteria, viruses and other hazardous microorganisms. Lay individuals might not take the proper precautions when dealing with sewage or use proper sanitizing procedures after sewage is released. The release of sewage-contaminated water can also expose individuals to illnesses such as salmonella, shigella, E. coli and hepatitis A. These diseases can later transfer from person-to-person.

Additional dangers after a release or water of sewage from drainage pipes include electrocutions, explosions, fire, gas release, flooding, destruction of valuables and serious damage to infrastructure. In the case of electrocutions or release of gas, wires or gas lines might come into direct contact with standing water or soggy materials. A utility company might not be available to immediately shut off gas or electrical lines. In addition, an on-site professional might not be available to assess an affected area for potential electrical shocks and additional gas leaks. This puts homeowners, plumbers or other individuals in serious and potentially fatal situations.

Most clean-outs have removable elements such as caps or plugs that permit access to drains. These elements minimize the requirements of removing additional plumbing fixtures in order to clear water or debris from a drainage system. The relative load of weight of most drainage systems could include 100 to 200 gallons of water. The overflow water from the drain stoppage can cause serious bodily harm to a plumber, other individuals and property. The release of hot water, dead organic waste, harsh chemicals or sewer gas in a drainage system can further escalate the harm.

The safety clean-out cap as described herein will assist plumbers with the removal of clean-out cap devices in tight or compressed spaces, assist with drainage and promote the horizontal or vertical flow of water or sewer towards the exterior of a building. The device is simple to install and operate. In both vertical and horizontal arrangements of the pipes, the release of a valve creates the negative pressure to help clear a drainage system before a plumber arrives. The vertical and horizontal flow of debris and water is effective and would prevent potential flooding and release of toxic materials in a plumber's workspace.

Various devices for flushing and removing obstructions in waste pipes or sinks by means of a tube connected to a water main exist in the prior art. The multi purpose clean-out attachment (U.S. Pat. No. 3,936,892A) provides for a plumbing fitting that can be installed along any drain line to permit easy flushing in the event of a clog. A length of pipe having interior and exterior threading is connected to the drain by means of an external screw thread at one end and an internal screw thread at the opposite end. A branch line is connected to one side of the attachment and is adapted to receive a clean-out rod. This device is not designed to facilitate the clean-out process in cramped spaces or allow for the pre-release of water and debris before addressing clogs in drainage systems.

The flushing attachment for sinks (U.S. Pat. No. 831,722A) was invented in 1905. The flushing attachment consists of a branch pipe located on an outlet-pipe between the trap and the sewer. The branch pipe has a valve-inlet opening which is normally closed but is adapted to be connected to the inlet end of the branch pipe and to be secured to either the hot or cold water faucet located adjacent the outlet-pipe. A valve in the branch and water lines can be released into the outlet-pipe below the trap. This flushing attachment for sinks is not practical on a larger scale and in drainage problems in toilets, sewers and other drainage scenarios that would require a clean-out cap. As shown, it is used mainly for clogs in sinks whereby the hose is held in position between a faucet and the branch of the outlet-pipe and is thereby secured to both.

The decorative and magnetic clean-out caps presented in United States patent application number 20160138748A1 comprise a cap portion and a magnet. A magnet is coupled to the cap portion of the clean-out cap and can magnetically engage with a clean-out engagement device. This device does not have the practical safety and reach features that would be necessary in emergency situations. The cap portion of the device is configured to hide a drain clean-out until access is required.

U.S. Pat. No. 976,593A provides for a clean-out attachment for bath wastes and overflows by cleaning the connecting sections between the bath waste and overflow. The waste pipe as described was a clean-out device having a rod formed with traversely extending cross bars. The clean-out device is connected to the outside of a stopper having apertures for the connection of the rod. The clean-out attachment is used to clean the connecting sections between the bath waste and the overflow. It is not used to access and direct the flow of waste and water outside of the drainage system.

Various devices have been invented to sieve the debris and other particulates from a direct flow of water from drainage pipe systems. The debris collector for water drainage pipes was described in U.S. Pat. No. 3,465,885A. The device features the combination of a debris collector unit and drainage means. The drainage functions as a pipe with an outlet that transports waste and other deposits to a base structure. The base structure is a primary passageway for fluid. This debris collector arrangement from waste drainage pipes does not provide the convenient connections and access points to sewer systems for further sewer cleaning and maintenance.

Clean-out caps and plugs are offered commercially in multiple sizes to fit various types of plumbing arrangements. Some are offered as slotted clean-out caps for flush applications that require a flush-finish on walls and sidewalks. Additional commercial applications include counter sunk clean-out caps and raised head clean-out caps. However, these applications would first require the removal of the clean-out cap and any sewage, water or debris would be drained in a pan or bucket. Removal of the clean-out cap would also pose additional problems in narrow, tight or constricted conditions.

To this end, there is a long felt need in the art for a new clean-out cap that is adapted to prevent damage to infrastructure or the spread of diseases is presented. The present invention helps to overcome the problems associated with operating the traditional clean-out cap by allowing a user to flush water and debris from a drain in narrow, tight or constricted conditions without first removing a clean-out cap. In the event that a drain is routed in close proximity to a wall, machinery, electrical outlets or other types of obstructions, water and debris can be drained out of a backed up drain without causing damage and possibility spreading disease and other bacteria or viruses to areas that are in close vicinity to the drain.

Access to drainage clean-outs is also becoming a relevant issue as many states continue to regulate and propose additional water legislations. There is a need for a more efficient clean-out system as states regulate water flow rates for various plumbing fixtures. State officials can also require the quick and efficient removal of any clean-outs to determine if an entire drainage system is in compliance with state code. Therefore, testing might require that the traps of an entire drainage system are filled with water and individual clean-out caps would be removed in a quick and efficient manner. These testing conditions can include restaurants, hospital rooms, schools, libraries, computer rooms and other areas that would require minimal spillage of water and debris.

In the case of serious plumbing defects or plumbing components that have been installed incorrectly, the invention as described herein can be employed. For example, an outdated plumbing system in commercial office buildings can have clean-out caps positioned eight feet above the ground and on top of large electrical transformers. This positioning and the subsequent release of water and debris could be a life threatening experience for a plumber. The best approach would be to cut the drain line a long distance away from the original clean-out location and reconstruct a safer clean-out system.

The work of a plumber is often a messy and time-consuming experience. The diversity of the every day water supply systems and the debris, disease, bacteria, viruses and other toxic substances in drainage systems makes the work even more dangerous. The clean-out cap as described herein is a modern approach to an age-old problem with drainage systems. A plumber can work with the security that one of the most life risking parts of the job has greatly been lowered.

### BRIEF SUMMARY OF THE INVENTION

In view of the foregoing disadvantages associated with clean-out caps, the improved clean-out cap of the present invention provides an improved system for closing a drain opening. As such, the general purpose of the present invention is to provide a new and improved clean-out cap with compression surface areas to grip the clean-out cap. The compression surface areas would prevent plumbing tools and additional devices from slipping and spinning after being exposed to water, dirt or other damp media.

Another objective of the present invention is to provide a safety clean-out cap for a drain system having a downwardly opening flow channel being mounted permanently within the opening of a clean-out cap. The flow channel is oriented at a downward angle relative to the opening of the clean-out cap. A rectangular recess cooperatively receives a plumbing tool in a clearance sufficiently spaced to remove the clean-out cap. A flow channel with the rectangular recess feature cooperatively provides a plumber with an angular reach and displacement of plumbing tools in a tight or compressed setting.

Another objective of the present invention is to provide a safety clean-out cap for a drain system having a vertical channel extending at a 180-degree angle from a clean-out cap. A plurality of longitudinal rails is attached to the front portion of the vertical channel and would facilitate the expedient removal of the clean-out cap. The longitudinal rails are patterned so that portions of the top surface of the vertical channel and the back portion of the vertical channel are visible to the user.

Another objective of the present invention is to provide a safety clean-out cap for a drain system having a vertical channel extending at a 180-degree angle and having a plurality of longitudinal plates being attached to the dorsal end of the vertical channel. The longitudinal plates are attached to each other at a 90-degree angle and extend the entire circumference of the vertical channel. The longitudinal plates are receiving members for tools in a tight or compressed setting.

Another objective of the present invention is to provide a safety clean-out cap for a drain system having a square-shaped channel with interior threading and extending at a 180-degree angle from the clean-out cap. Similarly, the square-shaped channel is a receiving member for plumbing tools in a tight or compressed setting.

Still another objective of the present invention is to have a safety clean-out cap attached to fittings and pipe sections in order to regulate the flow of fluid from a drainage system. The fittings, pipe sections and hose sections would further regulate and prevent the release of water and debris from a drainage system. This feature s particularly helpful in multi-story buildings or in situations where a drainage system is designed above electrical units or sensitive areas within a building.

Henceforth, a clean-out cap that allows a plumber to easily remove a clean-out cap would fulfill a need in the plumbing industry. This invention utilizes and combines known technologies in a new configuration in order to overcome a long felt need in the art.

Additional advantages of the invention will become apparent from the following detailed description taken in conjunction with the accompanying drawings.

### BRIEF DESCRIPTION OF THE SEVERAL VIEWS OF THE DRAWING

FIG. 1 is perspective view of the flow channel.

FIG. 2 is a left side view of the flow channel.

FIG. 3 is a right side view of the flow channel.

FIG. 4 is a front view of the flow channel.

FIG. 5 is a back view of the flow channel.

FIG. 6 is an exemplary view of the flow, channel fittings and pipe sections.

FIG. 7 is a perspective view of the vertical channel and the longitudinal rails.

FIG. 8 is a front view of the vertical channel and the longitudinal rails.

FIG. 9 is a back view of the vertical channel.

FIG. 10 is an exemplary view of the vertical channel, fittings and pipe sections.

FIG. 11 is a perspective view of the vertical channel and the longitudinal plates.

FIG. 12 is a front view of the vertical channel and the longitudinal plates.

FIG. 13 is an exemplary view of the vertical channel, longitudinal plates, fittings and pipe sections.

FIG. 14 is perspective view of the square-shaped channel.

FIG. 15 is a right side view of the square-shaped channel.

FIG. 16 is an exemplary view of the square-shaped channel, fittings and pipe sections.

### DETAILED DESCRIPTION OF THE INVENTION

The present invention derives from the recognition that access to clean-out caps 26 is directed by the size, angle, location and access point of a drain system. The quick removal of various parts of a plumbing fixture including clean-out caps 26 can be advantageous. This would provide relief to plumbers and related professions by providing and employing a clean-out cap 26 that is designed to provide easy access in case of clogs both inside and outside of a building.

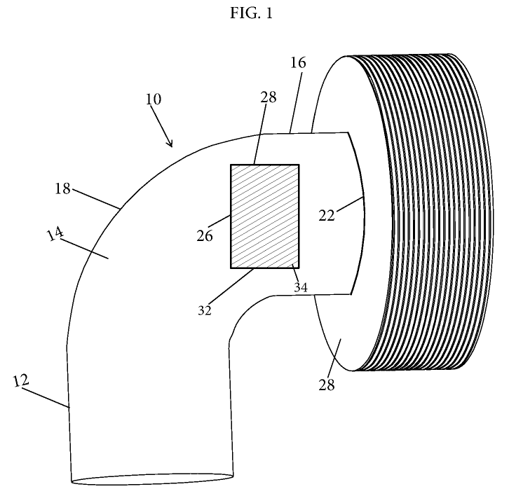

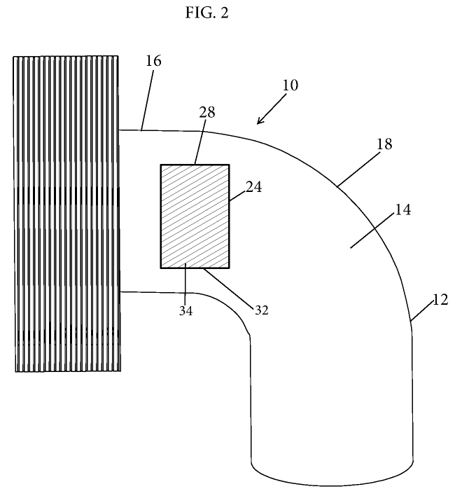

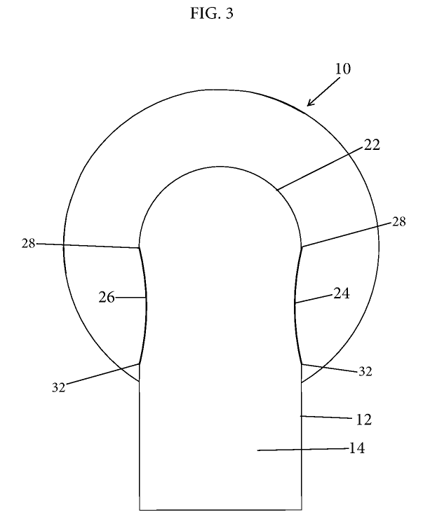

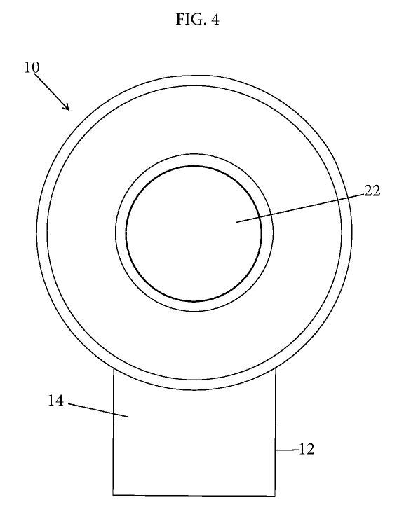

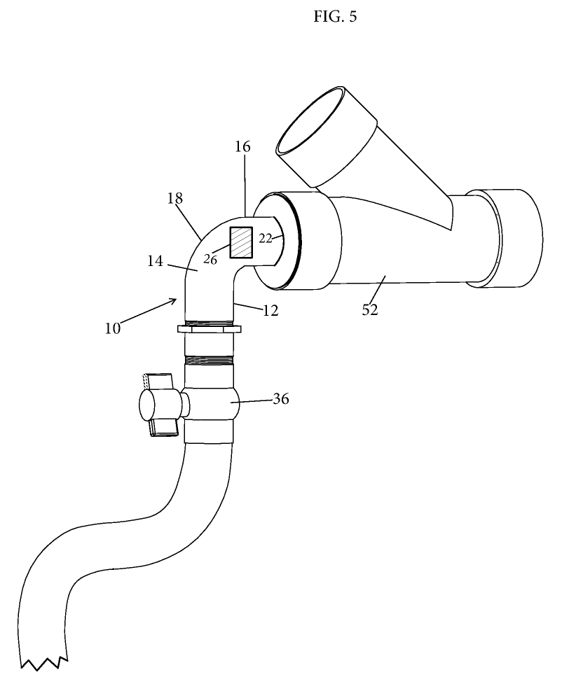

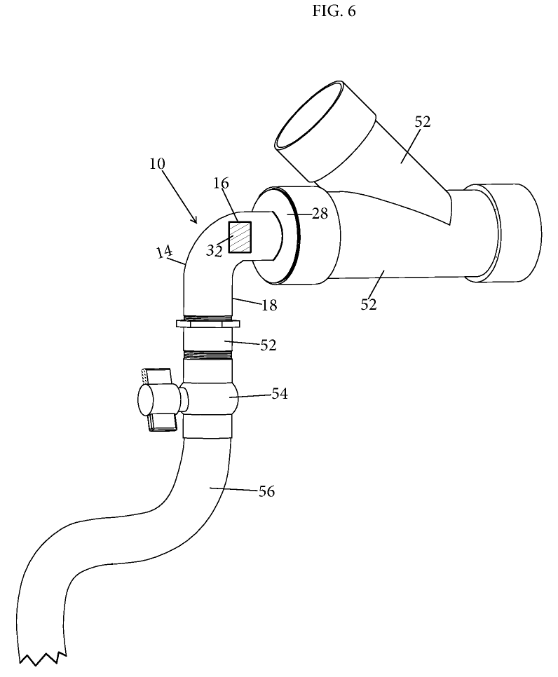

In reference now to the drawings, which are examples of the various clean-out cap 26 devices of the invention, and which should not be construed as limiting to shape size and form, the first embodiment of a novel clean-out cap 26 having a flow channel 10 is indicated in FIGS. 1 to 6. The safety clean-out cap 26 having a flow channel 10 for drain systems further comprises the flow channel 10 having an interior cavity 12, a top surface 14, a rectangular recess 16, a back wall 18, and a flow channel outlet 22. The flow channel 10 is a downwardly opening flow channel 10 that is mounted permanently within the opening of the clean-out cap 24 and is oriented at a downward angle relative to the opening of the clean-out cap 24. The downward angle forms a downward bend that is diametrically opposed to the top surface of the clean-out cap 28. The flow channel 10 bends at a 90-degree angle just below the rectangular recess 16. The flow channel 10 is generally circular and provides a clearance for receipt of water and debris from a drain. It is further adapted to receive tools for removal of debris from a drain. The types of tools can include clean-out plug wrenches, pullers, reseaters, fitting removal tools and 4-way wrenches. The water releases from a drainage system can include urine, laundry waste and various types of dissolved or suspended impurities. Various types of debris components that can be extracted from a sewer line include feces, sanitary towels, plastics, garden waste and food particles.

The top surface 14 has a rectangular recess 16 to cooperatively receive a tool. The rectangular recess 16 is disposed inwardly above the downward bend of the flow channel 10 and has a grab bar 32 that is engaging in the rectangular recess 16.

The back wall 18 of the flow channel 10 has a clearance that is adapted to receive a tool. The flow channel inlet forms a top opening for the interior cavity 12 of the flow channel 10 and the flow channel inlet directs water or debris towards the flow channel outlet 22. The flow channel outlet 22 is a bottom opening for the interior cavity 12 of the flow channel 10.

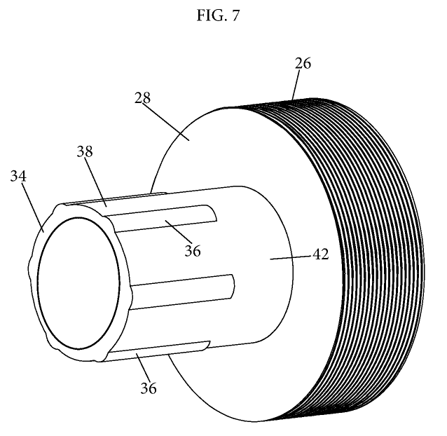

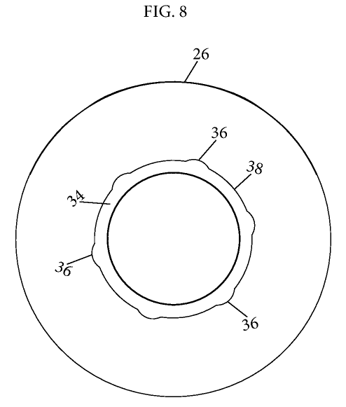

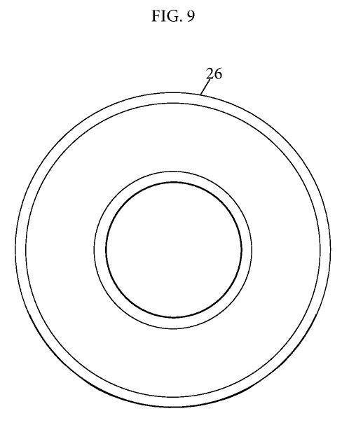

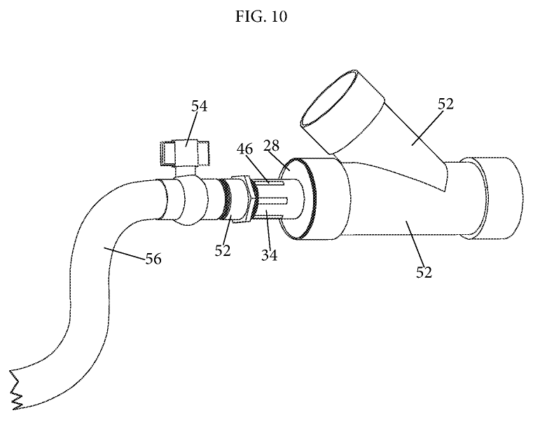

In FIGS. 7 to 10 there is a second example of another embodiment of a safety clean-out cap 26 where a vertical channel 34 extending at a 180-degree angle from the clean-out cap 26 directs the flow of water and debris from a clog inside a drainage system. The vertical channel 34 is permanently affixed to the top surface of the clean-out cap 28 and features a plurality of longitudinal rails 36. Each longitudinal rail 36 is attached to the front portion of the vertical channel 34. The longitudinal rails 36 extend laterally towards the top surface of the clean-out cap 28. The rails 36 are patterned so that portions of the top surface of the vertical channel 38 and the back portion 42 of the vertical channel are visible to the user. The longitudinal rails 36 are receiving members for tools as described above. For example, the jaw of a pipe wrench can easily grab a longitudinal rail 36 and with a slight wedging action, the cleanout-cap 26 is tightened or loosened away from a drainpipe.

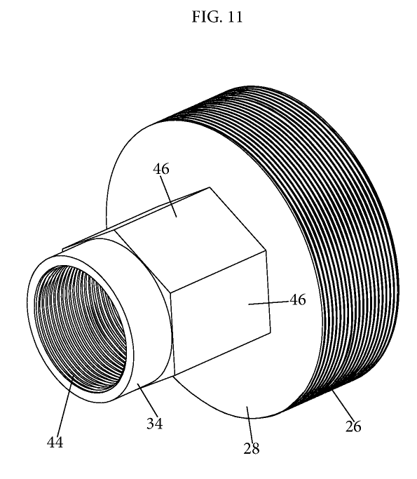

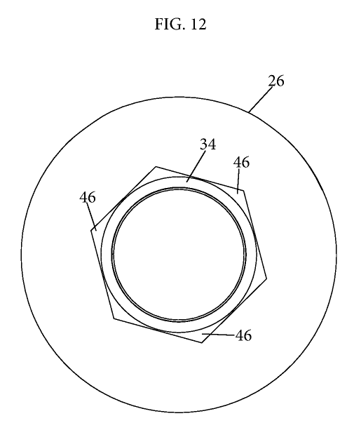

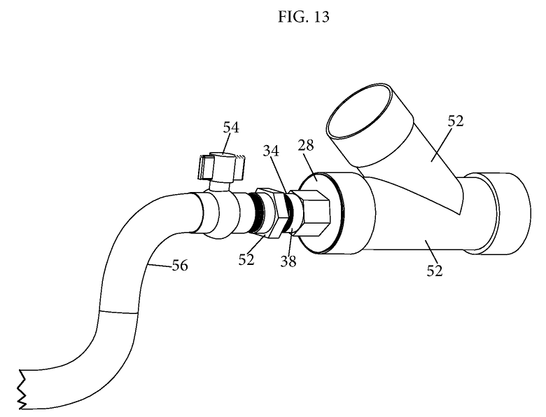

In FIGS. 11 to 13 there is shown a safety clean-out cap with a vertical channel 34 having interior threading 44. The vertical channel 34 extends at a 180-degree angle from the clean-out cap 26 and the vertical channel 34 is permanently affixed to the top surface of the clean-out cap 28. The vertical channel 34 has a plurality of longitudinal plates 46 being attached to the dorsal end of the vertical channel 34. The longitudinal plates 46 are attached to each other at a 90-degree angle and extend the entire circumference of the vertical channel 34. The longitudinal plates 46 are receiving members for plumbing tools and present as angular plates for tightening and loosening of the clean-out cap 28 after water and debris have been drained.

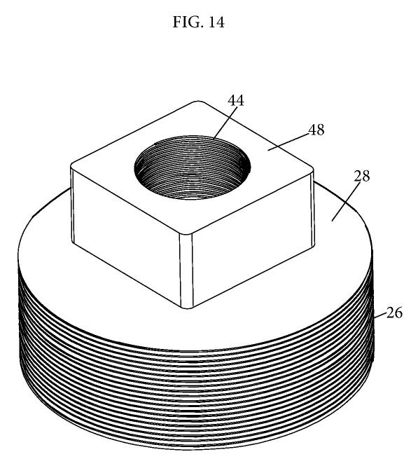

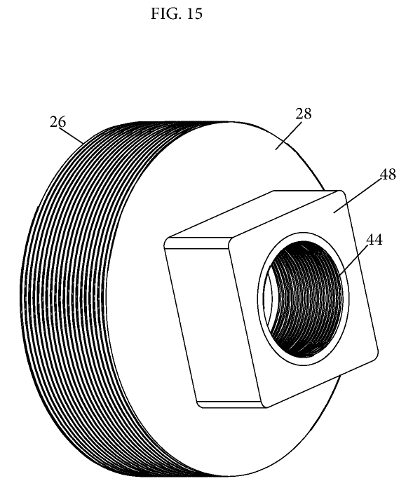

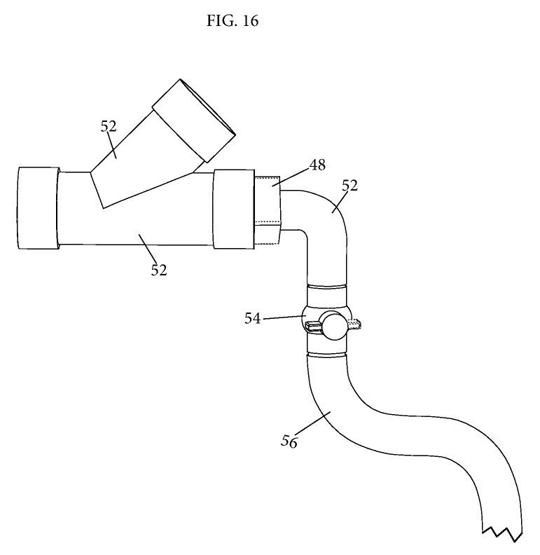

Referring now to FIGS. 14 to 16, a square-shaped channel 48 is seen having interior threading 44 and extending at a 180-degree angle from the clean-out cap 26. The square-shaped channel 48 is permanently affixed to the top surface of the clean-out cap 28. Similarly, the square-shaped channel 48 is a receiving member for tools such as clean-out plug wrenches, pullers, reseaters, fitting removal took and 4-way wrenches.

The flow channel 10, vertical channel 34 and square-shaped channel 48 are attached to fittings 52, pipes sections 54 and hose sections 56 in order to regulate the flow of fluid. Types of fittings 52 include valves, nipples, elbows, couplings and barbs. Cradles, straight pipes and curved pipes are common types of pipe sections 54 that can be used as prescribed herein. The fittings 52 and pipe sections 54 are typically constructed from brass, acrylonitrile butadiene styrene (ABS), polyvinyl chloride (PVC) or other materials approved by state, model or local building codes. Generally, the fittings 52, pipe sections 54 and hose sections 56 are flexible, rigid, durable, corrosion-resistant, and constructed at a low cost. This facilitates the use of the clean-out cap 26 above or below the ground.

The pipe sections 54 and hose sections 56 and as prescribed herein can be at least 2″ in diameter. Typical clean-out caps 26 and fittings 52 are 3″, 4″ or 6″ but the construction is capable of custom fitting 52 and therefore various sizes can be constructed for horizontal and vertical branches at the end of all drainpipes. The interior cavity 12 and channel outlets 22 can be sized as needed and based on the size, angle, location, access point, material type and volume of debris and water of a drain system. The channels 10, 34, 48 are adapted to remain in flow communication with a specific drain system. In essence, the devices will be sized to operate and to provide an acceptable rate of release of water based on the size of the sewer pipes.

What is claimed is:

1. (canceled)

2. (canceled)

3. (canceled)

4. (canceled)

5. (canceled)

6. (canceled)

7. (canceled)

8. (canceled)

9. A safety clean-out cap with an attached flow channel being permanently mounted within the opening of said safety clean-out cap, said safety clean-out cap further comprising: said flow channel having sidewalls, a turning segment and a downward bend; said turning segment being on the same lateral plane as said safety clean-out cap and having a right side depression and a left side depression; said right side depression and said left side depression extending above the downward bend of said flow channel and being centrally disposed in said sidewalls of said flow channel, said right side depression and said left side depression being curved inward of said side walls and being mounted on the opposite sides of said flow channel, said right side depression and said left side depression having a top lateral edge and a bottom lateral edge, said right side depression and said left side depression having tracks being formed to diverge inwardly between said top lateral edge and said bottom lateral edge, said right side depression and said left side depression having a substantially rectangular shape and cooperatively receiving and preventing tools from upward and downward movement along said sidewalls of said flow channel; said safety clean-out cap being attached to pipe fittings in order to regulate the flow of fluid.
